(19) United States
(12) Patent Application Publication
(10) Pub. No.: US 2019/0178156 A1
(43) Pub. Date: Jun. 13, 2019

(54) ENGINE DEVICE FOR VEHICLE

(71) Applicants: Hyundai Motor Company, Seoul (KR); Kia Motors Corporation, Seoul (KR)

(72) Inventors: Hyo Seong Wi, Suwon (KR); Kuen Sang Kim, Suwon (KR); Dae Kwang Kim, Yongin (KR); Jun Seong Kim, Daejeon (KR)

(21) Appl. No.: 16/028,466

(22) Filed: Jul. 6, 2018

(30) Foreign Application Priority Data
Dec. 8, 2017 (KR) 10-2017-0168658

(51) Int. Cl. F02B 67/06; F01P 5/12; F02B 63/04; F02B 63/06; F16D 27/04; F16D 13/76; F16D 13/40; F16H 55/36

(52) U.S. Cl. CPC F02B 67/06; F01P 5/12; F02B 63/042; F02B 63/06; F16H 2055/366; F16D 13/76; F16D 13/40; F16H 55/36; F01P 2005/125; F16D 27/04

(57) ABSTRACT

An engine device for a vehicle is configured such that a clutch pulley may be rotated together with a crankshaft or may not be rotated depending on the application of electric power. Therefore, when an auxiliary drive system does not need to rotate, the clutch pulley is prevented from rotating. Accordingly, torque loss attributable to dispersion of torque to the auxiliary drive system is minimized As a result, fuel efficiency is improved, and engine output is increased.

### CROSS-REFERENCE TO RELATED APPLICATION

This application claims under 35 U.S.C. § 119(a) the benefit of Korean Patent Application No. 10-2017-0168658, filed on Dec. 8, 2017 in the Korean Intellectual Property Office, the entire contents of which are incorporated by reference herein.

### BACKGROUND

### 1. Technical Field

The present disclosure relates to an engine device for a vehicle, which is capable of improving fuel efficiency by reducing an engine load attributable to continuous operation of an auxiliary drive system.

### 2. Description of the Related Art

In general, a vehicle includes an auxiliary drive system, which is rotated by torque from an engine. Such an auxiliary drive system includes a generator, a compressor for an air conditioner, a water pump, etc.

The torque generated by the operation of the engine is transferred to a crankshaft, and is subsequently transferred to various auxiliary devices, which constitute the auxiliary drive system, via belts connected to the crankshaft. To this end, the crankshaft and the auxiliary drive system are provided with pulleys to receive torque via the belts.

In recently developed vehicles, one integrated belt is connected to an auxiliary drive system. However, because a single belt is connected to the pulleys of the auxiliary drive system, all of the pulleys of the auxiliary drive system are rotated when the engine operates, and thus torque loss occurs.

Accordingly, the engine output is reduced, and fuel efficiency and operational efficiency are deteriorated.

The information disclosed in this Background section is only for enhancement of understanding of the general background of the disclosure and should not be taken as an acknowledgement or any form of suggestion that this information forms the prior art already known to a person skilled in the art.

### SUMMARY

Therefore, the present disclosure provides an engine device for a vehicle, which is capable of improving fuel efficiency by reducing an engine load attributable to continuous operation of an auxiliary drive system.

In accordance with the present disclosure, the above and other objects can be accomplished by the provision of an engine device for a vehicle, including a pulley unit connected with a crankshaft configured to be rotated by engine torque, the pulley unit being provided with a clutch pulley configured to be selectively rotated by the engine torque depending on whether electric power is applied, and an auxiliary drive system connected with the clutch pulley via a belt and configured to be rotated by torque from the clutch pulley. The pulley unit is configured such that the clutch pulley is not rotated when the auxiliary drive system is not rotated so as to minimize torque loss attributable to dispersion of engine torque.

The auxiliary drive system may include an air-conditioner compressor and an alternator, with a water pump provided separately.

The water pump may be an electric water pump that is selectively operated depending on application of electric power.

The engine device may further include a battery electrically connected to the alternator, and the battery may be a lithium ion battery.

The engine device may further include a controller determining whether to apply electric power to the pulley unit, and the controller may verify operation of a switch of an air conditioner or a state of charge of a battery. When the switch of the air conditioner is operated or when the state of charge of the battery reaches a predetermined capacity of the battery, the controller may control the pulley unit to rotate the clutch pulley.

The pulley unit may include a clutch pulley connected to the auxiliary drive system via a belt, a field coil assembly provided inside the clutch pulley and configured to generate electromagnetic force depending on application of electric power, and a disc hub assembly connected to the crankshaft inside the clutch pulley and configured to be engaged with the clutch pulley when the field coil assembly generates electromagnetic force due to application of electric power thereto so that the clutch pulley is rotated by the engine torque.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a view illustrating an engine device for a vehicle according to an exemplary embodiment of the present disclosure;

FIG. 2 is a block diagram of components of the engine device for a vehicle illustrated in FIG. 1; and

FIG. 3 is a view illustrating a pulley unit of the engine device for a vehicle according to the present disclosure.

### DETAILED DESCRIPTION OF THE PREFERRED EMBODIMENTS

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Reference will now be made in detail to the preferred embodiments of the present disclosure, examples of which are illustrated in the accompanying drawings. Wherever possible, the same reference numbers will be used throughout the drawings to refer to the same or like parts.

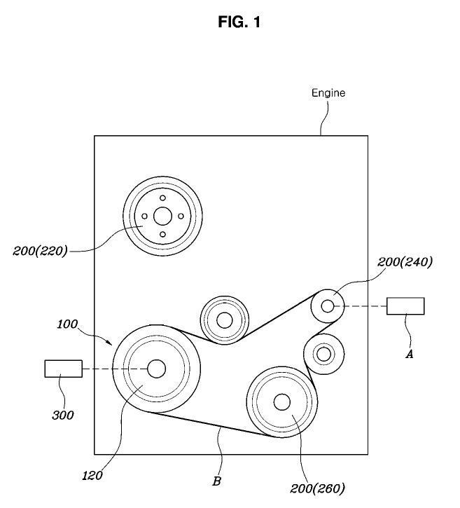

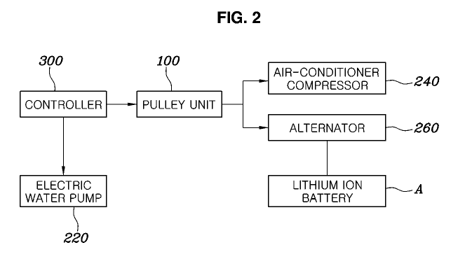

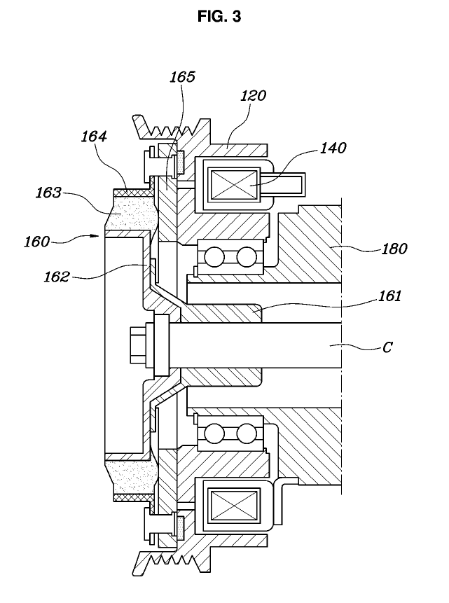

FIG. 1 is a view illustrating an engine device for a vehicle according to an exemplary embodiment of the present disclosure, FIG. 2 is a block diagram of components of the engine device for a vehicle illustrated in FIG. 1, and FIG. 3 is a view illustrating a pulley unit of the engine device for a vehicle according to the present disclosure.

In the following description of the present disclosure, an auxiliary drive system will be described as being configured to receive engine torque via a belt. However, devices that must be operated when an engine operates, for example, a steering hydraulic control system, a cam pulley, or the like, may receive engine torque via separate belts.

The present disclosure relates to a device for selectively transferring engine torque to the auxiliary drive system. Because a belt connection structure of an engine is a known technology that is widely used in industrial fields, a pulley unit according to the present disclosure will be mainly described in the following description.

As shown in FIGS. 1 and 2, the engine device for a vehicle according to the present disclosure may include: a pulley unit 100, which is connected with a crankshaft C configured to be rotated by engine torque and which is provided with a clutch pulley 120 configured to be selectively rotated by the engine torque depending on whether electric power is applied; and an auxiliary drive system 200, which is connected with the clutch pulley 120 via a belt B and which is rotated by torque from the clutch pulley 120. The pulley unit 100 is configured such that the clutch pulley 120 is not rotated when the auxiliary drive system 200 is not rotated, thereby minimizing torque loss attributable to dispersion of the engine torque. The tension of the belt B may be maintained by pulleys provided separately.

As such, the present disclosure is characterized in that the engine torque is selectively transferred to the auxiliary drive system 200 via the pulley unit 100 depending on whether the auxiliary drive system 200 needs to rotate. Accordingly, it is possible to minimize loss that may occur due to the transfer of the engine torque to the auxiliary drive system 200 when the auxiliary drive system 200 does not need to rotate. As a result, fuel efficiency is improved, and the engine output is increased.

In contrast, in the prior art, because a pulley of a crankshaft and pulleys of an auxiliary drive system are always connected to each other via a belt, all of the pulleys of the auxiliary drive system are rotated when the crankshaft are rotated. Thus, torque loss occurs due to continuous rotation of the auxiliary drive system.

In order to solve this problem, the pulley unit 100 according to the present disclosure includes the clutch pulley 120, which is rotated together with the crankshaft C but selectively transfers torque depending on whether electric power is applied. Accordingly, since the clutch pulley 120 of the pulley unit 100 is not rotated when the auxiliary drive system 200 is not rotated, the engine torque is not transferred to the auxiliary drive system 200, whereby torque loss is minimized Further, when the auxiliary drive system 200 needs to operate, the clutch pulley 120 of the pulley unit 100 is rotated, and the engine torque is transferred to the auxiliary drive system 200, whereby the auxiliary drive system 200 operates normally.

As such, since the engine torque is selectively transferred to the auxiliary drive system 200 depending on whether the auxiliary drive system 200 needs to rotate, torque loss is minimized, fuel efficiency is improved, and the engine output is increased.

A detailed description of the present disclosure will now be made. The auxiliary drive system 200 may include an air-conditioner compressor 240 and an alternator 260, with a water pump 220 provided separately.

That is, in the present disclosure, the devices that constitute the auxiliary drive system 200 are the air-conditioner compressor 240 and the alternator 260. The air-conditioner compressor 240 and the alternator 260 are provided with pulleys, which are connected to the belt B, so as to be rotated by engine torque. Because the water pump 220 is not connected to the crankshaft C via the belt B, the water pump 220 does not receive engine torque.

When an air conditioner, which is included in an air-conditioning system, is not operated, the pulley connected to the air-conditioner compressor 240 does not need to rotate. When the engine of the vehicle is initially started or when it is not necessary to charge a battery, the pulley connected to the alternator 260 does not need to rotate.

The water pump 220 needs to operate frequently after the engine is started due to its characteristics. Further, the operating conditions of the water pump 220 vary depending on the temperature of coolant. Thus, the water pump 220 does not receive the engine torque but is operated independently. That is, the water pump 220 may be an electric water pump, which is selectively operated depending on the application of electric power.

As described above, in the auxiliary drive system 200, the pulley of the air-conditioner compressor 240 and the pulley of the alternator 260 are connected to the clutch pulley 120 of the pulley unit 100 via the belt B, and the pulley unit 100 selectively allows the clutch pulley 120 to be rotated by the engine torque depending on whether the auxiliary drive system 200 needs to rotate. Accordingly, it is possible to minimize torque loss of the engine.

The water pump 220, which is embodied by an electric water pump, is electronically controlled in accordance with the engine load and the temperature of coolant. Since the operating conditions of the electric water pump are well known, a detailed description thereof will be omitted.

A battery A, which is electrically connected to the alternator 260, may be a lithium ion battery.

According to the present disclosure, the alternator 260 is not always operated, but performs a generation operation when the clutch pulley 120 is rotated by the rotation of the pulley unit 100. Since the battery A is embodied by a lithium ion battery, which has high charging efficiency and low power loss, the power may be maintained stable even though the alternator 260 is not always operated. If a general battery, which has relatively low charging efficiency, is used, the alternator 260 needs to be operated constantly, which may cause torque loss.

Therefore, in the present disclosure, the battery A is embodied by a lithium ion battery, whereby energy charging due to the generation of electric energy of the alternator 260 is achieved efficiently, and thus the extent of operation of the alternator 260 is reduced.

The pulley unit 100 is controlled by a controller 300. The controller 300 determines whether to apply electric power to the pulley unit 100. To this end, the controller 300 collects information about operation of a switch of the air conditioner or about a state of charge of the battery. When the switch of the air conditioner is operated or when the state of charge of the battery reaches a predetermined capacity of the battery, the pulley unit 100 may be controlled to rotate the clutch pulley 120.

As such, when the switch of the air conditioner is in an off state or when the state of charge of the battery is satisfactory, the controller 300 does not operate the pulley unit 100, and thus the clutch pulley 120 of the pulley unit 100 is not rotated. The predetermined capacity of the battery, which is stored in advance in the controller 300, may be set in accordance with the specification of the battery, and may be set to a level at which charging is required due to use of the power stored in the battery.

When the controller 300 receives a signal generated by user operation of the switch of the air conditioner or when the state of charge of the battery is insufficient, the controller 300 controls the pulley unit 100 so that the clutch pulley 120 receives the engine torque and rotates. Accordingly, the pulley of the air-conditioner compressor 240 and the pulley of the alternator 260, which are connected to the clutch pulley 120 via the belt B, are rotated together with the clutch pulley 120, whereby the air-conditioner compressor 240 and the alternator 260 operate normally.

Conversely, upon determining that the air conditioner is turned off or that the state of charge of the battery is sufficient, the controller 300 controls the pulley unit 100 so that the clutch pulley 120 does not receive the engine torque. Accordingly, it is possible to minimize the dispersion of the engine torque to the air-conditioner compressor 240 and to the alternator 260. As a result, the energy generated by the operation of the engine is used only for the rotation of the crankshaft C, and thus the engine output is increased.

As shown in FIG. 3, the pulley unit 100 includes: a clutch pulley 120, which is connected to the auxiliary drive system 200 via the belt B; a field coil assembly 140, which is provided inside the clutch pulley 120 and which is configured to generate electromagnetic force depending on the application of electric power; and a disc hub assembly 160, which is connected to the crankshaft C inside the clutch pulley 120 and which is configured to be engaged with the clutch pulley 120 when the field coil assembly 140 generates electromagnetic force due to the application of electric power thereto so that the clutch pulley 120 is rotated by the engine torque.

Through this configuration of the pulley unit 100, when the field coil assembly 140 generates electromagnetic force due to the application of electric power thereto, the disc hub assembly 160 is engaged with the clutch pulley 120, and consequently, the engine torque is transferred to the clutch pulley 120 via the disc hub assembly 160.

In particular, when electric power is applied to the field coil assembly 140 under the control of the controller 300, a disc of the disc hub assembly 160 is engaged with the clutch pulley 120 by magnetic induction generated by electromagnetic force of the field coil assembly 140, and the engine torque is transferred to the clutch pulley 120 and is subsequently transferred to the auxiliary drive system 200 via the belt B connected to the clutch pulley 120, whereby the auxiliary drive system 200 can rotate.

In another example, the pulley unit 100 may include: a housing 180, which is mounted to an engine case; a clutch pulley 120, which is rotatably provided around the housing 180; a field coil assembly 140, which is mounted inside the housing 180 and which is configured to generate electromagnetic force depending on the application of electric power; and a disc hub assembly 160, which includes a hub 161 coupled to the crankshaft C, an inner ring 162 coupled to the hub 161, an outer ring 164 coupled to the inner ring 162 via a damper 163, and a disc 165 coupled to the outer ring 164 and configured to be moved toward the clutch pulley 120 by the electromagnetic force.

Such a pulley unit 100 is configured based on a clutch hub device, which selectively transfers torque of a drive shaft, such as the crankshaft C, and various known structures other than the above-described structure may be applied to the pulley unit 100.

As is apparent from the above description, according to the engine device for a vehicle configured as described above, the clutch pulley may be rotated together with the crankshaft C or may not be rotated depending on the application of electric power. Therefore, when the auxiliary drive system 200 does not need to rotate, the clutch pulley is prevented from rotating. Accordingly, torque loss attributable to dispersion of torque to the auxiliary drive system is minimized As a result, fuel efficiency is improved, and engine output is increased.

Although the preferred embodiment of the present disclosure has been disclosed for illustrative purposes, those skilled in the art will appreciate that various modifications, additions and substitutions are possible, without departing from the scope and spirit of the disclosure as disclosed in the accompanying claims.

What is claimed is:

1. An engine device for a vehicle, comprising:
a pulley unit connected with a crankshaft configured to be rotated by engine torque, the pulley unit being provided with a clutch pulley configured to be selectively rotated by the engine torque depending on whether electric power is applied; and
an auxiliary drive system connected with the clutch pulley via a belt and configured to be rotated by the engine torque,
wherein the pulley unit is configured such that the clutch pulley is not rotated when the auxiliary drive system is not rotated so as to minimize torque loss attributable to dispersion of the engine torque.

2. The engine device according to claim 1, wherein the auxiliary drive system comprises an air-conditioner compressor and an alternator, with a water pump provided separately.

3. The engine device according to claim 2, wherein the water pump is an electric water pump that is selectively operated depending on application of electric power.

4. The engine device according to claim 2, further comprising:
a battery electrically connected to the alternator,
wherein the battery is a lithium ion battery.

5. The engine device according to claim 1, further comprising:
a controller determining whether to apply electric power to the pulley unit,
wherein the controller verifies operation of a switch of an air conditioner or a state of charge of a battery, and
wherein, when the switch of the air conditioner is operated or when the state of charge of the battery reaches a predetermined capacity of the battery, the controller controls the pulley unit to rotate the clutch pulley.

6. The engine device according to claim 1, wherein the pulley unit comprises:
a clutch pulley connected to the auxiliary drive system via a belt;
a field coil assembly provided inside the clutch pulley and configured to generate electromagnetic force depending on application of electric power; and
a disc hub assembly connected to the crankshaft inside the clutch pulley and configured to be engaged with the clutch pulley when the field coil assembly generates electromagnetic force due to application of electric power thereto so that the clutch pulley is rotated by the engine torque.
